(19) United States
(12) Patent Application Publication
(10) Pub. No.: US 2011/0177242 A1
(43) Pub. Date: Jul. 21, 2011

(54) FAST CURING OIL-UPTAKING EPOXY-BASED STRUCTURAL ADHESIVES

(75) Inventors: Dirk Kolowrot, Duesseldorf (DE); Matthias Popp, Bremen (DE)

(73) Assignee: 3M Innovative Properties Company

(21) Appl. No.: 13/121,875

(22) PCT Filed: Sep. 25, 2009
(86) PCT No.: PCT/US09/58413

§ 371 Date: Mar. 30, 2011

(30) Foreign Application Priority Data
Sep. 30, 2008 (GB) 0817795.8

(51) Int. Cl. B05D 5/10; C08L 63/00

(52) U.S. Cl. 427/207.1; 523/455; 523/428

(57) ABSTRACT

Two-part adhesive compositions are described. The two-part adhesives have a first part and a second part, said composition comprising at least one aromatic epoxy resin in the first part; at least one amine curing agent in the second part; and at least one ester in at least one of the first and/or second part. The ester corresponds to the general formula R²—CO—OR¹; wherein R¹ is an organic moiety comprising at least one of (i) at least one epoxy group or (ii) at least one acryl group and R² is a branched alkyl group. The structural adhesive may be used to form bonded joints between adherents having clean surfaces, as well as those having surfaces contaminated with hydrocarbon-containing materials, such as oils, processing aids and lubricating agents.

### FIELD

The present disclosure relates to two-part epoxy-based adhesives. The present disclosure also relates to methods of making and using the two-part epoxy-based adhesives.

### BACKGROUND

Structural adhesives are typically thermosetting resin compositions that may be used to replace or augment conventional joining techniques such as screws, bolts, nails, staples, rivets and metal fusion processes (e.g., welding, brazing and soldering). Structural adhesives are used in a variety of applications that include general-use industrial applications, as well as high-performance applications in the automotive and aerospace industries. To be suitable as structural adhesives, the adhesives should exhibit high mechanical strength, high impact resistance and/or a bond strength comparable to those achieved by mechanical fastenings.

The surface of an adherend (typically a metal surface, ceramic surface, alloy surface, glass surface etc, in particular an automotive part or an aircraft component) is often contaminated with hydrocarbon-containing materials which, if left untreated, can lead to undesirable bond failure at the adhesive/adherend interface. Contaminants may include mill and corrosion protection oil, lubrication oils or greases, fingerprints, and other grime and soil found in manufacturing processes and warehousing.

Removing hydrocarbon-containing material from surfaces of adherends can be difficult. Mechanical processes such as dry wiping and/or the use of pressurized air tend to leave a thin layer of the hydrocarbon-containing material on the surface. Liquid cleaning compositions can be effective but may be less desirable from a processing point of view because the cleaning liquid must be collected and recycled or discarded. In addition, a drying period is usually required after the cleaning step. Therefore, a need exists within the industry for structural adhesives that form strong adhesive bonds on clean surfaces, as well as surfaces contaminated with hydrocarbon-containing material.

Epoxy adhesives are known to strongly bond to metal surfaces and for its use as structural adhesives. Typically, these adhesives provide adequate bonding when used in a situation where the bonded substrate is exposed to heat immediately (heat-curing). However, in some situations the bonded substrate is left at room temperature for a period of time before curing at an elevated temperature. One such situation exists in vehicle assembly plants. Adhesives used to hold metal vehicle panels together are spot cured by induction heating in several places to hold the panels in place, but a significant portion of the adhesive is left uncured at ambient temperature until the vehicle gets painted and run through a paint bake cycle to cure the paint and the adhesive. The vehicle can be left at ambient temperature for any amount of time from several minutes to several days depending upon when the vehicle is run through the paint bake cycle. In these situations the adhesives generally do not build as high of a shear strength as desired or do not build it as rapidly as desired. Additionally, the failure mode in these situations is often an adhesive failure wherein the adhesive pulls cleanly away from one of the substrates, indicating poor adhesion. It is generally desirable to have structural adhesives fail in a cohesive mode wherein the adhesive splits and portions of the adhesive remain adhered to each of the bonded surfaces. A bond that fails cohesively is referred to as being “robust”.

Therefore, there is a desire to find an adhesive epoxy composition that is capable of wetting out on oily metal surfaces to form a robust, structural bond not only on clean but also on contaminated, in particular, on oily or greasy surfaces. Desirably, the adhesive rapidly builds up strong adhesive bonds (as measured by over lap shear) upon curing at room temperature. Preferably, the adhesive compositions show a cohesive failure mode. Preferably, the adhesives are capable of forming, after complete curing, structural bonds, i.e. bonds between substrates of comparable strength to mechanical fastening.

### SUMMARY

In the following there is provided a two-part adhesive composition having a first part and a second part, said composition comprising:
at least one aromatic epoxy resin in the first part;
at least one amine curing agent in the second part; and
at least one ester in at least one of the first and/or second part, wherein the ester corresponds to the general formula

R²—CO—OR¹

wherein

R¹ is an organic moiety comprising at least one of
(i) at least one epoxy group or
(ii) at least one acryl group; and

R² is a branched alkyl group.

In another aspect there is provided a cured composition obtainable by combining and curing the parts of the curable composition above.

In a further aspect there is provided a method of making a composite article, the method comprising applying the two-part adhesive composition above to a surface; and curing the two-part adhesive composition to form a composite article.

In yet another aspect there is provided the use of an ester of the formula above for accelerating bonding strength of an epoxy adhesive composition on metal surfaces.

### DETAILED DESCRIPTION

Before any embodiments of the disclosure are explained in detail, it is to be understood that the disclosure is not limited in its application to the details of construction and the arrangement of components set forth in the following description. The disclosure is capable of other embodiments and of being practiced or of being carried out in various ways. Also, it is to be understood that the phraseology and terminology used herein is for the purpose of description and should not be regarded as limiting. Contrary to the use of “consisting”, the use of “including,” “containing”, “comprising,” or “having” herein is meant to encompass the items listed thereafter and equivalents thereof as well as additional items. The use of “a” or “an” is meant to encompass “one or more”. Any numerical range recited herein includes all values from the lower value to the upper value. For example, if a concentration range is stated as 1% to 50%, it is intended that values such as 2% to 40%, 10% to 30%, or 1.5% to 3.9%, etc., are expressly enumerated. These are only examples of what is specifically intended, and all possible combinations of numerical values between and including the lowest value and the highest value enumerated are to be considered to be expressly stated in this application.

The present disclosure relates to two-part epoxy-based structural adhesives that may be applied to clean substrates, as well as substrates contaminated with hydrocarbon-containing materials. The two-part epoxy-based structural adhesives comprise at least one aromatic epoxy resin, at least one amine curing agent, and at least one low molecular weight ester compound having a terminal epoxy or acrylic acid functional group. It has been found that the addition of the low molecular weight esters to epoxy adhesives may achieve stronger or comparable bond strength as measured by T-peel tests after heat curing (complete curing) on contaminated substrates but also accelerates the build of bond strength as measured by overlap shear tests after curing at room temperature. The optimum ratios of the compounds can be adapted to the desired end properties of the compositions and identified through routine optimization experiments.

To adapt the rheological and/or mechanical properties the adhesives may further contain other ingredients. Additional epoxy resins and/or toughening agents may be added, for example, for increasing impact resistance, bond strength and/or toughness of the cured adhesive. Reactive liquid modifiers may be added to impart flexibility to the epoxy resin composition and/or to enhance the effect of the toughening agent. Fillers (particularly inorganic mineral fibers, organic fibers and/or fibers having aspherical and/or platelet structures) may be added to adapt the rheological properties, to promote adhesion, improve corrosion resistance, control the rheology and/or reduce shrinkage during curing. Reactive diluents may be added to control the flow characteristics of the compositions. Surfactants may be added to assist with oil-displacement on a substrate. Secondary curatives and/or catalysts may be added to further increase the curing of the composition.

The structural adhesives provided herein may be used to replace or augment conventional joining means such as welds or mechanical fasteners in bonding parts together.

Aromatic Epoxy Resins

The adhesive compositions described herein contain at least one aromatic epoxy resin. Aromatic epoxy resins as referred to herein are epoxy resins containing in the backbone or in a side chain—if present—at least one aromatic unit. Typically, the aromatic epoxy resins include at least one aromatic epoxide, such as for example a glycidyl ether, preferably at a terminal position of the resin backbone or side chain—if present. Aromatic epoxy resins that can be used include, for example, the reaction product of phenols or (phenols and formaldehyde) and epichlorohydrin, peracid epoxies, glycidyl esters, glycidyl ethers, the reaction product of epichlorohydrin and amino phenols, the reaction product of epichlorohydrin and glyoxal tetraphenol and the like. Phenols as referred to above include polynuclear phenols (i.e. compounds having at least two phenol functional groups). Typical examples of polynuclear phenols are bisphenols.

Suitable saturated epoxy resins include aromatic glycidyl ethers (e.g., those that may be prepared by reacting a dihydric phenol (i.e. a phenol with another functional group having a reactive proton such as for example a hydroxyl group) with an excess of epichlorohydrin). Examples of useful dihydric phenols include resorcinol, catechol, hydroquinone, and the polynuclear phenols including p,p′-dihydroxydibenzyl, p,p′-dihydroxyphenylsulfone, p,p′-dihydroxybenzophenone, 2,2′-dihydroxyphenyl sulfone, p,p′-dihydroxybenzophenone, 2,2-dihydroxy-1,1-dinaphrhylmethane, and the 2,2′, 2,3′, 2,4′, 3,3′, 3,4′, and 4,4′ isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylmethane, dihydroxydiphenylpropylenphenylmethane, dihydroxydiphenylbutylphenylmethane, dihydroxydiphenyltolylethane, dihydroxydiphenyltolylmethylmethane, dihydroxydiphenyldicyclohexylmethane, and dihydroxydiphenylcyclohexane.

Suitable commercially available aromatic epoxides include diglycidylether of bisphenol A (e.g., available under the trade designations “EPON 828,” “EPON 872,” “EPON 1001,” “EPON 1310,” and “EPONEX 1510” from Hexion Specialty Chemicals Inc., Houston, Tex., USA), “DER-331,” “DER-332,” and “DER-334” (available from Dow Chemical Co. in Midland, Mich., USA); diglycidyl ether of bisphenol F (e.g., available under the trade designation “EPICLON 830” from Dainippon Ink and Chemicals, Inc.; Tokyo, JP). Other epoxy resins based on bisphenols are commercially available, for example, under the trade designations “D.E.N.,” (Dow Chemical Company, Midland, Mich., USA) “EPALLOY,” (CVC Thermoset Specialities, Moorestown, N.J., USA) and “EPILOX (Leuna Harze GmbH, Leuna, Germany).”

The backbone of the aromatic epoxy resin may contain substituents. Substituent groups can be any group not having a nucleophilic group or electrophilic group (such as an active hydrogen atom) which is reactive with an oxirane ring. Exemplary substituent groups include halogens, ester groups, ethers, sulfonate groups, siloxane groups, nitro groups, amide groups, nitrile groups, and phosphate groups.

The molecular weight (weight average) of the saturated epoxy resins may range from about 100 g/mole for monomeric or oligomeric resins to 50,000 g/mole or more for polymeric resins. Suitable epoxy resins are typically liquid at room temperature (i.e., 25° C.). However, soluble solid epoxy resins may also be used.

Unsaturated Epoxy Resins

The compositions as provided herein may further contain one or more unsaturated epoxy resins The unsaturated epoxy resins may contain one or multiple, epoxy functional groups and one or multiple ethylenically unsaturated groups per molecule, such as for example but not limited to terminal unsaturated groups. The ethylenically unsaturated groups may be derived from polymerizable carboxylic acids or their derivatives, such as for example acrylic acid or its derivatives. Preferably, the unsaturated curable epoxy resins are curable epoxy acrylates or polyacrylates. The term “unsaturated epoxy resins” as used herein refers to aliphatic carbon-carbon double bonds (ethylenical type of unsaturation) and not to aromatic carbon-carbon double bonds.

Suitable epoxy groups of the unsaturated epoxy resins can be any oxirane-bearing moieties including glycidyloxy groups as shown in general formula (I). Formula (I) represents a typical unsaturated epoxy resin of the glycidyl ether type, wherein R³ represents the resin backbone comprising the one or more curable ethylenically unsaturated moieties and n represents an integer greater than 1.

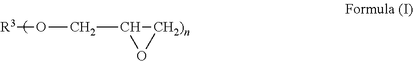

Suitable resins may be aromatic or aliphatic, cyclic or acyclic, monofunctional or polyfunctional. The backbone of the resin may be of any type, and substituent groups thereon can be any group not having a nucleophilic group or electrophilic group (such as an active hydrogen atom) which is reactive with an epoxy group. Exemplary substituent groups include halogens, ester groups, ethers, sulfonate groups, siloxane groups, nitro groups, amide groups, nitrile groups, and phosphate groups.

Such resins may be liquids at room temperature. However soluble solid epoxy resins may also be used. The epoxy resins may have an epoxy group content of 4000 to 7000, or from about 5,000 to about 6,000 mmol/kg (ASTM D1652) or from about 5,600 to about 5,800 mmol/kg. Suitable resins may have a viscosity at 25° C. of about 500 to about 3,000 or from about 800 to about 1,200 mPa.s (ASTM D445).

Curable unsaturated epoxy resins are known and can be prepared, for example by methods as disclosed in U.S. Pat. No. 6,747,101 to Roth et al. and references cited therein. Curable unsaturated epoxy resins are also commercially available, for example under the trade designation “EPON EPDXY POLYACRYLATES” from Hexion Speciality Chemicals Inc, Houston, Tex., USA.

The unsaturated epoxy resin may be a different resin than the aromatic resin or it may be part of the aromatic resin. In the former the composition comprises at least two different epoxy resins, an aromatic epoxy resin and an unsaturated epoxy resin. In the latter the composition comprises an aromatic resin that also contains unsaturated groups as described above. Preferably, the composition comprises a first epoxy resin, which is an aromatic epoxy resin and a second epoxy resin, which is an unsaturated epoxy resin.

In some embodiments, the adhesive compositions described herein may comprise from about 20% to about 90% by weight epoxy resin. In other embodiments, the structural adhesives may comprise from about 40% to about 70% by weight epoxy resin. In yet other embodiments, the adhesives may comprise from about 50% to about 70% by weight epoxy resin. Percent weight is based upon the total weight of the two-part structural adhesive (i.e., in case of a two-part adhesive, the combined weights of Parts 1 and 2).

Curing Agents

The adhesives provided herein also comprise at least one or more curing agents capable of cross-linking the curable epoxy resins. Typically these agents are primary or secondary amines. The amines may be aliphatic, cycloaliphatic, aromatic, or aromatic structures having one or more amino moieties.

Suitable amine curing agents include those amines having the general formula (II):

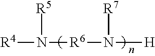

wherein R⁴, R⁵, R⁶ and R⁷ are each independently hydrogen or a hydrocarbon containing from about 1 to 15 carbon atoms, wherein the hydrocarbons include polyethers; and the value for n ranges from about 1 to 10. In some embodiments, the curing agent is a primary amine. In the same, or other, embodiments, R⁶ is a polyetheralkyl.

Exemplary amine curing agents include ethylenediamine, diethylenediamine, diethylenetriamine, triethylenetetramine, propylene diamine, tetraethylenepentamine, hexaethyleneheptamine, hexamethylenediamine, 2-methyl- 1,5-pentamethylene-diamine, 4,7,10-trioxatridecan-1,13 -diamine, amino ethylpip erazine and the like.

In some embodiments, the amine curing agent is a polyether amine having one or more amine moieties, including those polyether amines that can be derived from polypropylene oxide or polyethylene oxide. Commercially available polyether amines include the polyether polyamines (available under the trade designation “JEFFAMINE” from Huntsman Corporation, The Woodlands, Tex., USA) and 4,7,10-trioxatridecane-1,13-diamine (TTD) (available from BASF, Ludwigshafen, Germany).

In some embodiments, the adhesives provided herewith may comprise from about 3 to about 30% by weight amine curing agent. In other embodiments, the adhesives may comprise from about 5 to about 15% by weight amine curing agent.

The molar ratio of epoxide moieties to primary or secondary amine hydrogens can be adjusted to achieve optimum performance through routine experimentation. Adhesives of the present disclosure may have a molar ratio of epoxy moieties on the curable epoxy resin to amine hydrogens on the amine curing agent ranging from about 0.5:1 to about 3:1. In some embodiments, the molar ratio is about 2:1. In other embodiments, the molar ratio is about 1:1.

Secondary Curatives

In some embodiments, the adhesives of the present disclosure may optionally comprise a secondary curative. Secondary curatives according to the disclosure include imidazoles, imidazole-salts, imidazolines or aromatic tertiary amines including those having the structure of formula (III):

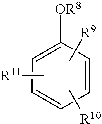

wherein

R⁸ is H or alkyl (e.g., methyl or ethyl);

R⁹ is CHNR⁵R⁶;

R¹⁰ and R¹¹ may be, independently from each other, present or absent and when present R¹⁰ and R¹¹ are CHNR¹²R¹³; and

R¹² and R¹³ are, independent from each other, alkyl (e.g., CH₃ or CH₂CH₃);

An exemplary secondary curative is tris-2,4,6-(dimethylaminomethyl)phenol (available under the trade designation “ANCAMINE K54” from Air Products Chemicals in Europe B.V).

Low molecular weight ester

The adhesive compositions provided herewith further comprise one or more low molecular weight ester. Such esters have been found to promote adhesion between the adhesive composition and the surface of adherends contaminated with hydrocarbon-containing material. The term “hydrocarbon-containing material” refers to a variety of surface contaminants that may result from the processing, handling, and storage of adherends. Examples of hydrocarbon-containing materials include mineral oils, fats, dry lubes, deep drawing oils, corrosion protection agents, lubricating agents and waxes. However, a surface may comprise other contaminating agents in addition to the hydrocarbon-containing material. Sufficient bond strengths using adhesives comprising the low molecular weight esters may be obtained without the need for a heat cure step.

Low molecular weight esters of the present disclosure are generally liquid compounds. They correspond to the general formula (IV)

R²—CO—OR¹

wherein

R¹ is an organic moiety comprising at least one of (i) at least one epoxy group or

(ii) at least one acryl group,

R² is a branched alkyl group.

R¹ may be an aliphatic or aromatic, preferably aliphatic, residue. The residues have at least one epoxy groups and/or at least one acryl group. Epoxy groups include the epoxy groups described above for epoxy resins. Acryl groups include acrylic acid and derivatives thereof, in particular methacrylic acid and its derivatives. Preferably, the epoxy or acry groups are in the terminal position. The alkyl residue may be non-substituted or substituted, for example by alkyl, alkoxy, or hydroxy alkyl residues. Preferably R¹ contains less than 20, more preferably, less than 10 carbon atoms.

R² is a branched alkyl residue, preferably of the general formula (V)

—(CH₂)ₙ—C(Ri)(Rii)(Riii)

wherein

Ri represents H, or a linear, cyclic or branched alkyl residue having from 1 to 12 carbon atoms, preferably a methyl, ethyl or propyl group and more preferably a methyl group;

Rii represents a linear, cyclic or branched alkyl residue having from 1 to 12 carbon atoms,

Riii represents a linear, cyclic or branched alkyl residue having from 1 to 12 carbon atoms, and

n represents 0, 1, 2, 3, 4, 5, 6, 7, 8, 9 or 10, preferably 1, 2 or 3, more preferably 1.

Preferably, R² contains less than 20 carbon atoms, and more preferably, R² contains less than 20 carbon atoms and is of the general formula

—C(Ri)(Rii)(Riii),

wherein Ri represents methyl or ethyl.

In some embodiments R² contains less than 20 carbon atoms and more preferably R² contains less than 20 carbon atoms and is of the general formula

—C(Ri)(Rii)(Riii),

wherein Ri is methyl or ethyl and R¹ is an acrylate or epoxy-group bearing alkyl residue, which may be non-substituted or substituted, for example, by alkyl, alkoxy, or hydroxy alkyl residues. Preferably R¹ contains less than 20, more preferably, less than 10 carbon atoms. More preferably, R¹ is epoxy- or acrylate-terminated.

The low molecular weight esters may be obtained, for example, by reacting acrylic acid or its derivatives including its oligomers with glycidyl tert-alkanoates or sec-alkanoates. Suitable embodiments therefore include reaction products of acrylic acid or methacrylic acid with glycidyl tert-alkanoate or sec-alkanoates. The glycidyl tert or sec alkanoates may contain from 10 to 25 carbon atoms, preferably from 10 to 15 carbon atoms.

The low molecular weight esters may also be obtained by reacting epichlorohydrin or its derivatives including its oligomers with tertiary or secondary carboxylic acids. The carboxylic acid may contain from 10 to 25 carbon atoms, preferably from 10 to 15 carbon atoms.

The adhesives provided herein may comprise from about 0.001% to about 50% by weight of the low molecular weight esters. In other embodiments, the adhesives may comprise from about 0.01% to about 25% by weight oil-displacing agent. In yet other embodiments, the adhesives may comprise from about 2% to about 10% by weight the low molecular weight ester.

Low molecular weight esters as provided herein are also commercially available, for example, under the trade designations “ACE” and “CARDURA E10P” from Hexion Speciality Chemicals, B.V., Hoogvliet, NL.

The “ACE” low molecular weight ester has the chemical structure

H₂C═CCOOC(CH₂OH)CH₂OOCC(CH₃)R₁₄R₁₅,

wherein R₁₄ and R₁₅ are alkyl residues having in total 7 carbon atoms. The CARDURA E10P low molecular weight ester has the chemical structure

Ox-CH₂—O—CO—C(CH₃)R₁₆R₁₇,

wherein Ox represents an oxirane residue (ethylene oxide) and R₁₆ and R₁₇ are alkyl residues having in total 7 carbon atoms.

The low molecular weight esters provided herein may be used to improve the adhesion of epoxy resins to surfaces, in particular metal surfaces contaminated with or protected by liquid, solid or oily hydrocarbon-containing material. The low molecular weight esters provided herein may alternatively or additionally be used for increasing the build up of bond strength, for example measured by overlap shear tests, on substrates, in particular metal substrates and preferably metal substrates contaminated with or protected by liquid solid or oily hydrocarbon-containing material.

Toughening Agents

Toughening agents are polymers, other than the epoxy resins described above, capable of increasing the toughness of cured epoxy resins. The toughness can be measured by the peel strength of the cured compositions. Typical toughening agents include core/shell polymers, butadiene-nitrile rubbers, acrylic polymers and copolymers, etc. Commercially available toughening agents (including that available, for example, under the trade designation “DYNAMAR POLYETHERDIAMINE HC 1101” from 3M Company, St. Paul, Minn., USA) and carboxyl-terminated butadiene acrylonitrile (available, for example, from Emerald Chemical, Alfred, Me., USA).

In some embodiments, the adhesives of the present disclosure may comprise from about 5% to about 55% by weight toughening agent. In other embodiments, the adhesives may comprise from about 5% to about 30% by weight toughening agent. In yet other embodiments, the adhesives may comprise from about 5% to about 15% by weight toughening agent.

Suitable toughening agents include core/shell polymers. A core/shell polymer means a polymer having a core/shell architecture. Core/shell polymers are prepared by providing a polymer (“core”) onto which polymers forming the “shell” are grafted.

The core polymer may have a glass transition temperature lower than 0° C. Typically the core comprises or consists of a polymer selected from the group consisting of a butadiene polymer or copolymer, an acrylonitrile polymer or copolymer, an acrylate polymer or copolymer and combinations thereof. The polymers or copolymers may be cross-linked or not cross-linked. In some embodiments, the core polymers are cross-linked.

Onto the core is grafted one or more polymers, the “shell”. The shell polymer typically has a high glass transition temperature, i.e. a glass transition temperature greater than 26° C. The glass transition temperature may be determined by dynamic mechanical thermo analysis (DMTA). The “shell” polymer may be selected from the group consisting of a styrene polymer or copolymer, a methacrylate polymer or copolymer, an acrylonitrile polymer or copolymer, or combinations thereof. The thus created “shell” may be further functionalized with epoxy groups or acid groups. Functionalization of the “shell” may be achieved, for example, by copolymerization with glycidylmethacrylate or acrylic acid. In particular, the shell may comprise acetoacetoxy moieties in which case the amount of acetoacetoxy-functionalized polymer may be reduced, or it may be completely replaced by the acetoacetoxy-functionalized core/shell polymer.

The shell of suitable core/shell polymers may comprise a polyacrylate polymer or copolymer shell such as, for example, a polymethylmethacrylate shell. The polyacrylate shell, such as the polymethylmethacrylate shell, may not be cross-linked.

The core of suitable core/shell polymers may comprise a butadiene polymer or copolymer, a styrene polymer or copolymer, or a butadiene-styrene copolymer. The polymers or copolymers making up the core, such as a butadiene-styrene core, may be cross-linked.

In some embodiments, the core/shell polymer according to the present disclosure may have a particle size from about 10 nm to about 1,000 nm. In other embodiments, the core/shell polymer may have a particle size from about 150 nm to about 500 nm. Combinations of core/polymers may also be used, for example mixtures of core/shell polymers having bimodal or multimodal particle size distributions.

Suitable core/shell polymers and their preparation are for example described in U.S. Pat. No. 4,778,851 to Henton et al. Commercially available core/shell polymers may include, for example, those available under the trade designations “PARALOID EXL 2600” and “PARALOID EXL 2691” from Rohm & Haas Company, Philadelphia, Pa., USA) and “KANE ACE MX120” from Kaneka in Belgium).

Reactive Liquid Modifiers

Reactive liquid modifiers may optionally be added to impart flexibility to the curable epoxy resin and enhance the effect of the toughening agent in the resultant adhesive.

Reactive liquid modifiers of the present disclosure may include acetoacetoxy-functionalized compounds containing at least one acetoacetoxy group, preferably in a terminal position. Such compounds include acetoacetoxy group(s) bearing hydrocarbons, such as alkyls, polyether, polyols, polyester, polyhydroxy polyester, polyoxy polyols, and combinations thereof

The acetoacetoxy-functionalized compound may be a polymer. In some embodiments, the acetoacetoxy-functionalized compounds of the present disclosure may have a molecular weight of from about 100 g/mol to about 10,000 g/mol. In other embodiments, the acetoacetoxy-functionalized compounds may have a molecular weight of from about 200 g/mol to about 1,000 g/mol. In yet other embodiments, the acetoacetoxy-functionalized compounds may have a molecular weight of from about 150 g/mol to less than about 4,000 g/mol or less than about 3,000 g/mol. Suitable compounds include those having the general formula (VI).

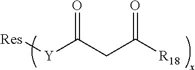

wherein

R₁₈ represents a C1-C12 linear or branched or cyclic alkyl such as methyl, ethyl, propyl, butyl, sec-butyl, tert-butyl, etc.;

X is an integer from 1 to 10. In some embodiments, X is an integer from 1 to 4. If the reactive liquid modifier comprises a mixture of compounds varying in X, the average number of acetoacetoxy groups per residue (Res) can be a non-integer number between 1 and 10. For example, in some embodiments, the average number of acetoacetoxy groups per residue (Res) may range from about 2 to 5. This includes embodiments where the average number of acetoacetoxy groups per residue (Res) is about 3.5;

Y represents O, S or NH. In some embodiments, Y is O; and

“Res” represents a residue selected from the group of residues consisting of polyhydroxy alkyl, polyhydroxy aryl or a polyhydroxy alkylaryl; polyoxy alkyl, polyoxy aryl and polyoxy alkylaryl; polyoxy polyhydroxy alkyl, -aryl, -alkylaryl; polyether polyhydroxy alkyl, -aryl or -alkylaryl; or polyester polyhydroxy alkyl, -aryl or -alkylaryl, wherein when X is 1 then Res is linked to Y via a carbon atom, and wherein, when X is other than 1, Res is linked to Y via the number of carbon atoms corresponding to X. In some embodiments, Res represents a polyether polyhydroxy -alkyl, -aryl or -alkylaryl residue, or a polyester polyhydroxy -alkyl, -aryl or -alkylaryl residue.

The residue (Res) may, for example, contain from 2 to 20 or from 2 to 10 carbon atoms. The residue may, for example, also contain from 2 to 20 or from 2 to 10 oxygen atoms. The residue may be linear or branched.

Examples of polyester polyhydroxy residues include polyester polyhydroxy residues obtainable from condensation reactions of a polybasic carboxylic acid or anhydrides and a stoichiometric excess of a polyhydric alcohol, or obtainable from condensation reactions from a mixture of polybasic acids, monobasic acids and polyhydric alcohols. Examples of polybasic carboxylic acids, monobasic carboxylic acids or anhydrides include those having from 2 to 18 carbon atoms. In some embodiments, the polybasic carboxylic acids, the monobasic carboxylic acids or the anhydrides have from 2 to 10 carbon atoms.

Examples of polybasic carboxylic acids or anhydrides include adipic acid, glutaric acid, succinic acid, malonic acid, pimleic acid, sebacic acid, suberic acid, azelaic acid, cyclohexane-dicarboxylic acid, phthalic acid, isophthalic acid, terephthalic acid, hydrophthalic acid (e.g., tetrahydro or hexadehydrophthalic acid) and the corresponding anhydrides, as well as combinations thereof.

Examples of monobasic carboxylic acids include formic acid, acetic acid, propionic acid, butyric acid, valeric acid, caproic acid, caprylic acid, capric acid, lauric acid, myristic acid, palmitic acid, stearic acid and the like, as well as combinations thereof.

Polyhydric alcohols include those having from 2 to 18 carbon atoms. In some embodiments, the polyhydric alcohols include those having from 2 to 10 carbon atoms. Examples of polyhydric alcohols include ethylene glycol, propylene glycol, butylene glycol, hexylene glycol, pentaerythriol, glycerol and the like, including polymers thereof.

Examples of polyetherpolyol residues include those derived from polyalkylene oxides. Typically, the polyalkylene oxides contain alkylene groups from about 2 to about 8 carbon atoms. In some embodiments, the polyalkylene oxides contain alkylene groups from about 2 to about 4 carbon atoms. The alkylene groups may be linear or branched. Examples of polyetherpolyol residues include polyethylene oxide polyol residues, polypropylene oxide polyol residues, polytetramethylene oxide polyol residues, and the like.

The acetoacetoxy-functionalized oligomers can be prepared by acetacetylation of polyhydroxy compounds with alkyl acetoacetates, diketene or other acetoacetylating compounds as, for example, described in EP 0 847 420 B1.

Other polyhydroxy compounds may be a copolymer of acrylates and/or methacrylates and one or more unsaturated monomers containing a hydroxyl group. Further examples of polyhydroxy polymers include hydroxyl-terminated copolymers of butadiene and acrylonitrile, hydroxy-terminated organopolysiloxanes, polytetrahydrofuran polyols, polycarbonate polyols or caprolactone based polyols.

Acetoacetoxy-functionalized polymers are commercially available, for example, under the trade designations “K-FLEX XM-B301” and “K-FLEX 7301”from King Industries, Norwalk, Conn., USA). In some embodiments, the reactive liquid modifier comprises a tri-acetoacetate functional ester.

Reactive liquid modifiers of the present disclosure may also include oxamides. Suitable oxamide-based modifiers may include oxamido ester terminated polypropylene oxide.

The adhesives of the present disclosure may comprise from about 5% to about 15% by weight reactive liquid modifier. In other embodiments, the structural adhesives may comprise from about 6% to about 12% by weight reactive liquid modifier. In yet other embodiments, the structural adhesives may comprise from about 6% to about 10% by weight reactive liquid modifier.

Catalysts

In some embodiments, structural adhesives of the present disclosure may comprise one or more catalysts. The catalysts are typically metal salts. Suitable catalysts which are operable in the present compositions include the group I metals (e.g., lithium), group II metals (e.g., calcium and magnesium) or lanthanoid salts (e.g., lanthanum) wherein the anion is selected from nitrates, iodides, thiocyanates, triflates, alkoxides, perchlorates and sulfonates. Exemplary metal salts include lanthanum nitrate, lanthanum triflate, lithium iodide, lithium nitrate, calcium nitrate and their corresponding hydrates.

In general, a catalytic amount of salt is employed. In some embodiments, the structural adhesive may contain from about 0.05 to less than 3.0% by weight metal salt.

Surfactants

Surfactants may optionally be added to the adhesive to assist with oil displacement on a substrate. Any surfactant that is soluble within the adhesive formulation may be used, including ionic surfactants, anionic surfactants, nonionic surfactants and zwitterionic surfactants. Exemplary surfactants include triproylene glycol monomethyl ether and polyethylene sorbitol.

Reactive Diluents

Reactive diluents may optionally be added to control the flow characteristics of the adhesive composition. Suitable diluents can have at least one reactive terminal end portion and, preferably, a saturated or unsaturated cyclic backbone. Reactive terminal end portions include glycidyl ether. Examples of suitable diluents include the diglycidyl ether of resorcinol, diglycidyl ether of cyclohexane dimethanol, triglycidyl ether of trimethylolpropane. Commercially available reactive diluents include those available under the trade designations “REACTIVE DILUENT 107” from Hexion Specialty Chemical, Houston, Tex., USA and “EPODIL 757” from Air Products and Chemical Inc., Allentown, Pa.

In some embodiments, the structural adhesive may contain from about 0.001 to 25% by weight reactive diluent.

Fillers

Fillers may optionally be added to the structural adhesives to, for example, promote adhesion, improve corrosion resistance, control the rheological properties of the adhesive, and/or reduce shrinkage during curing. Fillers may include silica-gels, Ca-silicates, phosphates, molybdates, fumed silica, amorphous silica, amorphous fused silica, clays such as bentonite, organo-clays, aluminium-trihydrates, hollow-glass-microspheres; hollow-polymeric microspheres and calcium carbonate. Commercial fillers include those available under the trade designations “SHIELDEX AC5” (an amorphous silica, calcium hydroxide mixture) from W. R. Grace, Columbia, Md., USA, “CAB-O-SIL TS 720” (a hydrophobic fumed silica-treated with polydimethyl-siloxane-polymer from Cabot GmbH in Hanau, Germany), AEROSIL VP-R-2935 (a hydrophobic silica from Degussa, Dusseldorf, Germany), “MICRO-BILLES DE VERRE 180/300” (amorphous silica from CVP S.A., France),“GLASS BUBBLES K37” (amorphous silica from 3M Company, St. Paul, Minn., USA), “MINSIL SF 20” amorphous silica from Minco Inc., Midway, Tenn., USA), and APYRAL 24 ES2 (epoxysilane-functionalized (2 wt %) aluminium trihydrate from Nabaltec GmbH, Schwandorf, Germany). In a preferred embodiment a combination of these commercial fillers.

Fillers may further include inorganic mineral fibers, organic fibers and fibers having aspherical and/or platelet structures.

Inorganic mineral fibers are fibrous inorganic substances made primarily from rock, clay, slag, or glass. Mineral fibers may include fiberglass (glasswool and glass filament), mineral wool (rockwool and slagwool) and refractory ceramic fibers. Particularly suitable mineral fibers may have fiber diameters on the average of less than 10 lam. In some embodiments mineral fibers may comprise from about 37% to about 42% by weight Si02, from about 18% to about 23% by weight Al2O3, from about 34% to about 39% by weight CaO+MgO, from 0% to about 1% by weight FeO, and about 3% by weight K20+Na2O. Commercially available fibers include, for example, under the trade designation “COATFORCE CF50” and “COATFORCE CF10” from Lapinus Fibres BV, Roermond, The Netherlands. Other fibers include wollastonite (available from Sigma-Aldrich, Milwaukee, Wis., USA).

Organic fibers may include high-density polyethylene fibers such as those available under the trade designations “SYLOTHIX 52,” “SYLOTHIX 53,”,” and “ARBOTHIX PE100” from EP Minerals, Reno, Nev., USA).

Fillers having aspherical and/or platelet structures may include those available under the trade designations “HUBER 70C” and “HUBER 2000C” from KaMin, LLC, Macon, Ga., USA), sepiolite, bentonite, and diatomaceous earth.

The structural adhesives of the present disclosure may comprise from about 0.001% to about 50% or from about 2% to about 40% by weight filler. This includes embodiments where the amount of filler in the structural adhesive ranges from about 2% to about 30% by weight filler and more particularly from about 2% to about 10% by weight filler.

In some embodiments, the structural adhesives of the present disclosure comprise at least one of inorganic mineral fibers, organic fibers, fillers having aspherical and/or platelet structures, and combinations thereof. In other embodiments, the structural adhesives comprise inorganic mineral fibers. In yet other embodiments, the structural adhesives comprise organic fibers.

Pigments

Pigments may include inorganic or organic pigments including ferric oxide, brick dust, carbon black, titanium oxide and the like.

Structural Adhesive Compositions

Two-part compositions according to the present disclosure comprise a Part 1 and, separate therefrom, a Part 2. Part 1 comprises a curable epoxy resin (unsaturated and if present also saturated epoxy resin) and Part 2 comprises an amine curing agent. Part 2 may comprise curable epoxy resin (saturated and/or unsaturated epoxy resin) in addition to that in Part 1. When used, reactive liquid modifiers are typically added to Part 1. As for any remaining ingredients (e.g., toughening agents, oil-displacing agents, secondary curatives, fillers, reactive diluents, metal salts, surfactants, pigments, etc.), compounds with epoxy reactive groups are preferably added to Part 2, compounds with amine reactive groups are preferably added to Part 1, and compounds that do not react with either an epoxy reactive group or an amine reactive group may be added to Part 1, Part 2 or a combination thereof Alternatively, a separate part for one or more of these ingredients may be contemplated.

In some embodiments, Part 1 comprises a curable epoxy resin, a toughening agent, and an oil-displacing agent, and Part 2 comprises an amine curing agent and a secondary curative. In other embodiments, a filler is added to Part 1 and/or Part 2, wherein the filler comprises at least one of an inorganic mineral fiber, an organic fiber, a fiber having aspherical and/or platelet structure, and combinations thereof

The two-part structural adhesive is prepared by mixing Parts 1 and 2 together. The amounts of Part 1 and Part 2 will depend upon the desired epoxy to amine hydrogen molar ratio in the structural adhesive. Structural adhesives of the present disclosure may have a molar ratio of epoxy moieties on the curable epoxy resin to amine hydrogens on the amine curing agent ranging from about 0.5:1 to about 3:1. In some embodiments, the molar ratio is about 2:1. In other embodiments, the molar ratio is about 1:1. The respective amounts of Part 1 and Part 2 are preferably mixed together immediately prior to use.

Bond Strength

It is desirable for the two-part epoxy-based adhesive to build a strong, robust bond to one or more substrates upon curing. A bond is considered robust if the bond breaks apart cohesively at high shear values when tested in an overlap shear test and high T-peel values when tested in a T-peel test. The bonds may break in three different modes: (1) the adhesive splits apart, leaving portions of the adhesive adhered to both metal surfaces in a cohesive failure mode; (2) the adhesive pulls away from either metal surface in an adhesive failure mode; or (3) a combination of adhesive and cohesive failure. The adhesives of the present disclosure may exhibit a combination of adhesive and cohesive failure, more preferably cohesive failure during overlap shear testing and/or T-peel testing. The adhesive may be applied to clean substrates or oiled substrates.

Curing

The structural adhesives of the present disclosure are room temperature curable and/or heat curable. In some embodiments, the adhesive may be cured at room temperature for at least 3 hours. This includes embodiments where the adhesive is cured at room temperature for at least 24 hours. This also includes embodiments where the adhesive is cured at room temperature for at least 72 hours.

In other embodiments, the adhesive is cured at room temperature followed by a post cure. This includes embodiments where the adhesive is cured at room temperature for about 18 hours followed by a post cure at about 180° for about 30 minutes.

In further embodiments, the adhesive may reach a desirable cohesive strength after short heat curing periods. Since the cohesive strength can still increase when curing the composition at the same conditions for longer periods, this kind of curing is referred to herein as partial curing (for example for reaching a green strength). In principle, partial curing can be carried out by any kind of heating. Preferably, compositions may be prepared using the ingredients described above in effective amounts to reach a bond strength of at least 90 N/25 mm after curing at 180° C. for 30 minutes as measured by T-peel test on a cleaned or oiled steel substrate. Compositions may also be prepared using the ingredients described above in effective amounts to reach bond strength of at least 0.8 MPa as measured by overlap shear test after curing at room temperature (25° C.) for 3 hours.

In some embodiments, induction curing (e.g., spot induction curing or ring induction curing) may be used for partial curing. Induction curing is a non-contact method of heating using electric power to generate heat in conducting materials by placing an inductor coil through which an alternating current is passed in proximity to the material. The alternating current in the work coil sets up an electromagnetic field that creates a circulating current in the work piece. This circulating current in the work piece flows against the resistivity of the material and generates heat. Induction curing equipment can be commercially obtained, for example, EWS from IFF-GmbH, Ismaning, Germany.

In yet a further embodiment, adhesives of the present disclosure may undergo an induction cure, followed by a room temperature cure and a post cure.

Use of Adhesive Compositions

The present adhesive compositions may be used to supplement or completely eliminate a weld or mechanical fastener by applying the adhesive composition between two parts to be joined and curing the adhesive to form a bonded joint. Suitable substrates onto which the adhesive of the present disclosure may be applied include metals (e.g., steel, iron, copper, aluminum, etc., including alloys thereof), carbon fiber, glass fiber, glass, ceramics, epoxy fiber composites, wood, and mixtures thereof. In some embodiments, at least one of the substrates is a metal. In other embodiments, both substrates are metal.

The surface of the substrates may be cleaned prior to application of the structural adhesive. However, the structural adhesives of the present disclosure are also useful in applications where the adhesives are applied to substrates having hydrocarbon-containing material on the surface. In particular, the structural adhesives may be applied to steel surfaces contaminated with a hydrocarbon-containing oil or wax, such as for example, mill oil, cutting fluid, draw oil, and the like.

In areas of adhesive bonding, the adhesive can be applied as liquid, paste, and semi-solid or solid that can be liquefied upon heating, or the adhesive may be applied as a spray. It can be applied as a continuous bead, in intermediate dots, stripes, diagonals or any other geometrical form that will conform to forming a useful bond. In some embodiments, the adhesive composition is in a liquid or paste form.

The adhesive placement options may be augmented by welding or mechanical fastening. The welding can occur as spot welds, as continuous seam welds, or as any other welding technology that can cooperate with the adhesive composition to form a mechanically sound joint.

The compositions according to the present disclosure may be used as structural adhesives. In particular, they may be used as structural adhesives in vehicle assembly, such as the assembly of watercraft vehicles, aircraft vehicles or motorcraft vehicles, such as cars, motor bikes or bicycles. In particular, the adhesive compositions may be used as hem-flange adhesives. The adhesive may also be used in body frame construction. The compositions may also be used as structural adhesives in architecture or as structural adhesives in household and industrial appliances.

The compositions may be used to promote the adhesion on metal surfaces contaminated with or protected by liquid, solid or oily hydrocarbon-containing material.

In some embodiments, the present disclosure provides a method of making a composite article, the method comprising applying the two-part adhesive of the present disclosure to a surface; and curing the two-part adhesive in contact with the surface to form a composite article.

In other embodiments, the present disclosure provides a method of forming a bonded joint between members, the method comprising applying the two-part adhesive of the present disclosure to a surface of at least one of two or more members, joining the members so that the two-part adhesive is sandwiched between the two or more members, and curing the two-part adhesive to form a bonded joint between the two or more members.

The composition may be used as a metal—metal adhesive, metal—carbon fiber adhesive, carbon fiber—carbon fiber adhesive, metal-glass adhesive, and carbon fiber—glass adhesive.

Exemplary embodiments of the two-part epoxy-based structural adhesives are provided in the following examples. The following examples are presented to illustrate the structural adhesive and methods for applying the structural adhesive and to assist one of ordinary skill in making and using the same. The examples are not intended in any way to otherwise limit the scope of the disclosure.

### EXAMPLES

Materials Employed

Low molecular weight ester 1: Hydroxy acrylate monomer (obtained from Hexion Specialty Chemicals B. V., Hoogvliet Rt., Netherlands under the trade designation “ACE”), a reaction product of 2-propenic acid with glycidyl tert decanoate.

Low molecular weight ester 2: Glycidyl ester of versatic acid (obtained under the trade designation “CARDURA E 10P” from Hexion Specialty Chemicals B. V., Hoogvliet Rt., Netherlands).

Technical grade tris-2,4,6-dimethylaminomethyl-phenol catalytic tertiary amine additive (obtained under the trade designation “ANCAMINE K54” from Air Products and Chemicals Inc., Allentown, Pa., USA).

A filler (obtained under the trade designation “APYRAL 24” from Nabaltec AG, Schwandorf, Germany).

n-Butyl Glycidyl Ether (obtained from Alfa Aesar, Ward Hill, Mass., USA).

A reactive diluent based on 1,4-cyclohexandimethanoldiglycidylether (obtained under the trade designation “EPODIL 757” from Air Products and Chemicals Inc., Allentown, Pa., USA).

Diglycidylether of bis-phenol A having an approximate epoxy equivalent weight of 187.5 (obtained under the trade designation “EPON 828” from Hexion Specialty Chemicals, Houston, Tex., USA).

Polyacrylate epoxy resin (obtained under the trade designation “EPON 8111” from Hexion Specialty Chemicals, Houston, Tex., USA).

2-Ethyl Hexyl Glycidyl Ether (obtained from Sigma-Aldrich Chemie GmbH, Munich, Germany).

Glass bubbles (obtained under the trade designation “GLASS BUBBLES K37” from 3M Company, St. Paul, Minn., USA).

Glycidyl methacrylate (obtained from Sigma-Aldrich Chemie GmbH, Munich, Germany).

Octyl/Decyl glycidyl ether (obtained from Sigma-Aldrich Chemie GmbH, Munich, Germany).

Methacrylate/butadiene/styrene polymer with a core/shell architecture (core cross-linked rubber comprising of a polybutadiene-co-polystyrene-copolymer; shell: polymethacrylate) with a particle size of about. 250 nm(obtained under the trade designation “PARALOID EXL 2600” from Rohm and Haas Company in Philadelphia, Pa., USA).

tert-Butyl Glycidyl Ether (obtained from TCI America, Portland, Oreg., USA).

4,7,10-trioxa-1,13-tridecane diamine (obtained under the trade designation “TTD” from BASF, Ludwigshafen, Germany).

Preparation of Adhesive Compositions

Preparation of Part A: Part A was prepared using the ingredients and amounts shown in the tables below. The amine curative (TTD) was heated to 80° C. Small portions of the aromatic epoxy resin (“EPON 828”) were added such that the temperature did not rise above 100° C. A secondary curative (“ANCAMINE K54”) was added and the mixture was stirred for further 5 minutes. The catalyst (calcium nitrate) was dispersed with a dispersing disk and the mixture was stirred for 6 hours. The remaining materials were added at 23° C. while stirring for 1 minute using a high speed mixer (obtained under the trade designation “DAC 150 FVZ SPEEDMIXER,” Hausschild Engineering, Germany) at 3000 rpm.

Preparation of Part B: Part B was prepared using the ingredients and amounts shown in the tables below. Epoxy resin (“EPON 828”) and toughening agent (“PARALOID EXL 2600”) were mixed stirring in a high speed mixer (“DAC 150 FVZ SPEEDMIXER””) at 3000 rpm for 1 minute. The mixture was heated to 80° C. and mixed again for one minute. The procedure was repeated until the toughener was completely dissolved (visual inspection). The mixture was cooled down to room temperature. The remaining ingredients were subsequently added and homogenized with a high speed mixer (“DAC 150 FVZ SPEEDMIXER”) stirring at 3000 rpm for 1 minute after each addition at 23° C.

Preparation of Adhesive Composition: Parts A and B were mixed using a speedmixer (“DAC 150 FVZ SPEEDMIXER'”') at 3000 rpm for 30 seconds.

Preparation of Test Panels

Cleaned Steel Panels. Hot-dip galvanised steel panels (150×25×0.67 mm, obtained from Ste Etalon, Ozoir-la-Farriere, France) were wiped with heptane and afterwards air dried. The ground side of the panel was used for all testing.

Oiled Steel Panels. Oiled steel panels were prepared by applying a sufficient volume of oil to the cleaned steel panels (described above) to achieve a coating of 3 g/m2 for the area to be coated, using density data obtained from the Material Safety and Data Sheet of the appropriate oil Material Safety Data Sheet (MSDS). The oil was spread uniformly over the surface of the substrate with a fingertip of a clean nitrile glove. The treated surface was stored at room temperature for 24 hours prior to use (dwell time).

Lap Shear Strength Measurements. Overlap shear strength was determined according to DIN EN 1465 using a tensile tester at a crosshead speed of 10 mm/min. The test-results were reported in MPa as average from three measurements. Equipment: tensile-tester (obtained under the trade designation “ZWICK/ROELL Z050” from Zwick GmbH & Co. KG, Ulm, Germany). Substrate: 100×25×0.67 mm strips of steel (described above).

Preparation of Test Assembly: The adhesive was applied on one end of the test substrate using a spatula followed by overlapping the ends of the treated strip with the end of the non-treated strip. The two ends were pressed against each other forming an overlap of 10 mm. Excess adhesive was then removed using a spatula. The overlapped strips were clamped at the adhesive ends using capacity binder clips. The clamped assembly was stored at ambient conditions for three days prior to being submitted to the overlap shear test.

T-Peel Strength Measurements. The-T-Peel strength was determined according to DIN EN 1464 using a tensile-tester (“ZWICK/ROELL Z050”) operating at a crosshead speed of 100 mm/min. The test results were reported in N/25 mm as average from three measurements.

150×25×0.67 mm steel strips (described above) were masked with a polytetrafluoroethylene tape (obtained under the trade designation “PTFE TAPE” (5490) from 3M Company, St. Paul, Minn.) leaving a blank area of 100 mm×25mm in order avoid flow of the adhesive over the extended area during the assembly of the strips. This guarantees a defined bondline resulting in a well defined crack during the measurement. The test adhesive was applied on the blank area of one strip of the substrate using a spatula followed by covering the area to which the adhesive was applied with a second strip of the test substrate. The strips were pressed against each other and residual adhesive was removed with a spatula. The assembly was clamped on both sides using capacity binder clips over the length of the bondline. The clamped assembly was stored at ambient conditions for 24 hours and then cured at 180° C. for 30 minutes in an oven prior to being submitted to the T-Peel test.

Results (1.) Effect of addition of oil-displacing compounds on the bond strength of epoxy adhesives

TABLE 1a
Composition of part B of the two part adhesives in wt % of A + B.

| | Reference | Exam- | Exam- | Exam- |
|---|---|---|---|---|
| Part B | Example 1 | ple 1 | ple 2 | ple 3 |
| EPON 828 | 38.0 | 33.4 | 24.5 | 29.3 |
| EPON 8111 | 0 | 0 | 12.1 | 5.9 |
| EPODIL 757 | 9.2 | 7.4 | 1.6 | 2.1 |
| PARALOID EXL 2600 | 6.9 | 6.1 | 4.5 | 6.0 |
| Fillers total | 27.1 | 23.8 | 25.9 | 26.5 |
| Glass bubbles (1) | 13.4 | 11.3 | 16.2 | 14.3 |
| Adhesion promoter (2) | 1.2 | 1.2 | 1.2 | 1.2 |
| Corrosion inhibitor (3) | 2.3 | 2.3 | 1.5 | 2.0 |
| Fused silica | 1.0 | 1.0 | 1.0 | 1.0 |
| Fumed silica | 9.2 | 8.0 | 6.0 | 8.0 |
| Low molecular weight | 0.0 | 0.0 | 12.1 | 0.0 |
| ester 1 (ACE) | | | | |
| Low molecular weight | 0.0 | 10.00 | 0.0 | 12.2 |
| ester 2 (CADURA E10P) | | | | |

(1) 3M ™ K37 glass bubbles (available from 3M Company)
(2) Silane Z-6040 adhesion promoter (3-glycidoxypropyl trimethoxysilane available from Dow Corning)
(3) SHIELDEX AC-5 (Calcium ion-exchanged amorphous silica available from Grace Davidson)

TABLE 1b
Composition of part A of the two-
part adhesives in wt. % of A + B.

| | Reference | Exam- | Exam- | Exam- |
|---|---|---|---|---|
| Part A | Example 1 | ple 1 | ple 2 | ple 3 |
| TTD | 8.1 | 8.3 | 8.4 | 8.2 |
| EPIKOTE 828 | 4.8 | 4.9 | 4.9 | 4.8 |
| ANCAMINE K54 | 1.5 | 1.5 | 1.5 | 1.5 |
| Ca(NO₃)₂ × 4 H₂O | 1.4 | 1.4 | 1.4 | 1.4 |
| Filler (APYRAL 24) | 3.0 | 3.1 | 3.1 | 3.1 |

TABLE 1c
Composition of the combined two-part adhesives.

| | Comparative | Exam- | Exam- | Exam- |
|---|---|---|---|---|
| | Example 1 | ple 1 | ple 2 | ple 3 |
| Total (A + B) wt %. | 100 | 100 | 100 | 100 |
| Wt. ratio of A:B | 1:4 | 1:4 | 1:4 | 1:4 |
| Ratio of equivalents | 2:1 | 2:1 | 2:1 | 2:1 |
| Epoxy:Amine | | | | |

TABLE 1d
Results of T-peel and overlap shear tests on oiled coupons.

| | Reference | Exam- | Exam- | Exam- |
|---|---|---|---|---|
| | Example 1 | ple 1 | ple 2 | ple 3 |
| T-Peel [N/25 mm] | 54 a | 160 c | 125 c | 139 c |
| Overlap shear after | 0.2 c | 0.9 c | 0.9 c | 0.9 c |
| 3 hours, room temper- | | | | |
| ature cure [MPa] | | | | |

a = adhesive failure
c = cohesive failure

The results shown in Table 1c (above) indicate that addition of an ester compound to an epoxy adhesive composition increases the bond strength of the fully cured composition (as measured by T-Peel) and also builds up adhesive strength (bond strength) more rapidly (as measured by over lap shear test) as shown by a comparison of Examples 1 to 3 with Reference Example 1.

Results (2.) Effect of esters compared to non-esters. To aid in comparing the results, details of Example 2 of results (1.) are repeated in the following tables.

TABLE 2a
Composition of part B of the two part adhesives in wt. % of A + B.

| | | | Refer- | | Refer- | Refer- |
|---|---|---|---|---|---|---|
| | | | ence | Reference | ence | ence |
| Part B | Ex 2 | Ex. 4 | Ex. 2 | Ex. 3 | Ex. 4 | Ex 5 |
| EPON 828 | 24.5 | 22.9 | 22.8 | 22.9 | 22.4 | 22.4 |
| EPON 8111 | 12.1 | 12.1 | 12.0 | 12.0 | 11.8 | 11.8 |
| EPODIL 757 | 1.6 | 1.7 | 1.6 | 1.6 | 1.6 | 1.6 |
| PARALOID | 4.5 | 4.7 | 4.7 | 4.7 | 4.6 | 4.6 |
| EXL 2600 | | | | | | |
| Filler total | 25.9 | 27.1 | 27.0 | 27.1 | 26.5 | 26.5 |
| Glass bubbles (1) | 16.2 | 17.9 | 17.8 | 17.9 | 17.3 | 17.3 |
| Adhesion | 1.2 | 0.8 | 0.8 | 0.8 | 0.8 | 0.8 |
| promoter (2) | | | | | | |
| Corrosion | 1.5 | 1.6 | 1.6 | 1.6 | 1.6 | 1.6 |
| inhibitor (3) | | | | | | |
| Fused silica | 1.0 | 0.6 | 0.6 | 0.6 | 0.6 | 0.6 |
| Fumed silica | 6.0 | 6.2 | 6.2 | 6.2 | 6.2 | 6.2 |
| Low molecular | 12.1 | — | — | — | — | — |
| weight ester 1* | | | | | | |
| Low molecular | — | 12.1 | — | — | — | — |
| weight ester 2** | | | | | | |
| 2-Ethyl hexyl | — | — | 12.0 | — | — | — |
| glycidyl ether | | | | | | |
| Octyl/decyl | — | — | — | 12.0 | — | — |
| glycidyl ether | | | | | | |
| tert. Butyl | — | — | — | — | 11.8 | — |
| glycidyl ether | | | | | | |
| glycidyl | — | — | — | — | — | 11.8 |
| methacrylate | | | | | | |

*ACE
**CARDURA E10P
(1) 3M ™ K37 glass bubbles (available from 3M Company)
(2) Silane Z-6040 adhesion promoter (3-glycidoxypropyl trimethoxysilane available from Dow Corning)
(3) SHIELDEX AC-5 (Calcium ion-exchanged amorphous silica available from Grace Davidson)

TABLE 2b
Composition of part A of the two-part adhesives in wt. % of A + B.

| | | | | | | Refer- |
|---|---|---|---|---|---|---|
| | | | Reference | Reference | Reference | ence |
| Part A | Ex 2 | Ex. 4 | Ex. 2 | Ex. 3 | Ex. 4 | Ex 5 |
| TTD | 8.4 | 8.4 | 8.6 | 8.5 | 9.2 | 9.3 |
| EPIKOTE | 4.9 | 4.9 | 5.0 | 5.0 | 5.4 | 5.4 |
| 828 | | | | | | |
| ANCAMINE | 1.5 | 1.5 | 1.6 | 1.6 | 1.7 | 1.7 |
| K54 | | | | | | |
| Ca(NO₃)₂ × | 1.4 | 1.4 | 1.5 | 1.5 | 1.6 | 1.6 |
| 4H₂O | | | | | | |
| Filler | 3.1 | 3.1 | 3.2 | 3.2 | 3.4 | 3.5 |
| (APYRAL | | | | | | |
| 24) | | | | | | |

TABLE 2c
Composition of the combined two-part adhesives in wt. %.

| | | | | Refer- | | Refer- |
|---|---|---|---|---|---|---|
| | | | Reference | ence | Reference | ence |
| | Ex 2 | Ex. 4 | Ex. 2 | Ex. 3 | Ex. 4 | Ex 5 |
| Total (A + B) | 100 | 100 | 100 | 100 | 100 | 100 |
| wt. % | | | | | | |
| Wt. ratio | 1:4 | 1:4 | 1:4 | 1:4 | 1:4 | 1:4 |
| of A:B | | | | | | |
| Ratio of | 2:1 | 2:1 | 2:1 | 2:1 | 2:1 | 2:1 |
| equivalents | | | | | | |
| Epoxy:Amine | | | | | | |

TABLE 2d
Results of T-peel and overlap shear tests on oiled coupons.

| | | | Ref. | Ref. | Ref. | Ref. |
|---|---|---|---|---|---|---|
| | Ex 2 | Ex. 4 | Ex. 2 | Ex. 3 | Ex. 4 | Ex 5 |
| T-Peel | 125 c | 135 c | 150 c | 114 c | 93 c | 22 a |
| [N/25 mm] | | | | | | |
| Overlap shear | 0.9 c | 1.8 a | 0.7 a | 0.7 a | 0.7 a | 0.6 a |
| after 3 hour | | | | | | |
| room | | | | | | |
| temperature | | | | | | |
| cure [MPa] | | | | | | |

a = adhesive failure
c = cohesive failure

The results show that compounds of similar structure to those claimed but not having the ester link do not accelerate the increase in bond strength as rapidly as compounds according to the claimed structure (compare the overlap shear results of Example 4 with Reference Examples 2 to 5).

The result also show that compounds having an ester link but only short chain residues do not accelerate the increase in bond strength as rapidly as the compounds according to the claimed structure (compare the results for Examples 2 and 4 with Reference Example 5).

1. A two-part adhesive composition having a first part and a second part, said composition comprising:
at least one aromatic epoxy resin in the first part;
at least one amine curing agent in the second part; and
at least one ester in at least one of the first and/or second part, wherein the ester corresponds to the general formula
R²—CO—OR¹
wherein
R¹ is an organic moiety comprising at least one of
(i) at least one epoxy group or
(ii) at least one acryl group; and
R² is a branched alkyl group.

2. The composition of claim 1 wherein R² is represented by the formula
—(CH₂)ₙ—C(RO(Rii)(Riii)
wherein
Ri represents H or an alkyl group having from 1 to 12 carbon atoms,
Rii represents an alkyl group having from 1 to 12 carbon atoms,
Riii an alkyl group having from 1 to 12 carbon atoms, and
n represents 0, 1, 2, 3, 4, 5, 6, 7, 8, 9 or 10.

3. The composition of claim 2 wherein Ri represents a methyl or an ethyl group.

4. The composition of claim 1, wherein R² comprises less than 20 carbon atoms.

5. The composition of claim 1, wherein the aromatic epoxy resin comprises at least one bisphenol glycidyl ether group.

6. The composition of claim 1, further comprising at least one toughening agent.

7. The composition of claim 1, wherein the aromatic epoxy resin comprises at least one aliphatic carbon-carbon double bond.

8. The composition of claim 1, further comprising a non-aromatic, unsaturated epoxy resin.

9. The composition of claim 8, wherein the non-aromatic, unsaturated epoxy resin is a polyacrylate epoxy resin.

10. The composition of claim 1, further comprising a metal salt.

11. A cured composition comprising the cured combination of the first part and the second part of the two-part adhesive composition of claim 1.

12. A method of making a composite article, the method comprising:
applying the two-part adhesive composition according to claim 1 to a surface; and
curing the two-part adhesive composition to form a composite article.

13. The method of claim 12, wherein the surface is a metal surface comprising a hydrocarbon-containing material.
